(19) United States
(12) Patent Application Publication
(10) Pub. No.: US 2016/0275262 A1
(43) Pub. Date: Sep. 22, 2016

(54) Computerized System and Method for Health Scoring and Health Risk Assessment

(71) Applicants: Preslav N. Panayotov, Varna (BG); Presyian Z. Dochev, Varna (BG)

(72) Inventors: Preslav N. Panayotov, Varna (BG); Presyian Z. Dochev, Varna (BG)

(21) Appl. No.: 14/662,675

(22) Filed: Mar. 19, 2015

(51) Int. Cl. G06F 19/00

(52) U.S. Cl. CPC G06F 19/3431

(57) ABSTRACT

A computerized method and system for health scoring and hearth risk assessment designed to help users to proactively manage their health is provided. Health-related activity may be tracked, monitored and processed to calculate an indicant of user overall health score and to perform a real-time health risk assessment. Health scores and health risk assessments may be used to help users to gain a better understanding of their overall health status and underlying health risk factors. This may lead to users taking a more proactive approach towards improving their health. Health scores may be a source of information not only for users, but also for health care providers, employers, insurers, and others. Information on health scores may be analyzed to determine the ranking, health score progress and health risk factors of the user. Additionally, health scores may be used to stimulate and reward users that demonstrate a preventative health care behavior.

### CROSS REFERENCE TO RELATED APPLICATIONS

This application claims the benefit under 35 U.S.C. 119(e) of U.S. Provisional Patent Application Ser. No. 61/955,382, filed on Mar. 19, 2014, entitled “Computerized system and method for the recognition, visualization and evaluation of the healthy living habits of households and individuals” which is hereby incorporated by reference as if set forth in its entirety herein.

### FIELD

Some embodiments in the present invention are related to the field of health and wellness technology, and more specifically to the creation of a computerized method and system for health scoring and health risk assessment aimed at improving one's health.

### BACKGROUND

Healthcare is one of the top social and economic problems facing Americans today. The rising cost of medical care and health insurance is impacting the livelihood of many Americans in one way or another. The inability to pay for necessary medical care is no longer a problem affecting only the uninsured, but is increasingly becoming a problem for those with health insurance as well.

One of the most troubling trends in recent years has been the rise in obesity among both adults and children in the U.S. More Americans than in the past say obesity is the most urgent health problem facing the United States, climbing to a new high of 16%. That compares with 1% in 1999, when Gallup began asking the question on an annual basis. According to a another study, the number of overweight people in the U.S. will grow to almost 42 percent of the country by 2030, and cost a whopping $550 billion in obesity-related health care costs per year.

Luckily, along with the list of such worrisome statistics, health care is in the midst of a game-changing transformation. As technological advances, government reforms, cost-saving measures, and shifting attitudes towards a healthier lifestyle are prompting people and organizations worldwide to think about health in new ways—and set new priorities.

Computerized devices may be used for a variety of tasks, for example, to monitor one's health vital signs, to send and receive drug inapproprateness alerts, to track physical activities and many others.

While regularly using computerized devices in their daily lives, users exert certain behavioral patterns that could be powerful predictors of their current and future health. The continuous tracking, determining and analyzing of such patterns could prove to be a powerful tool for improving overall health of users. Moreover, public and private health organizations could effectively utilize such information towards achieving higher level of optimization in the national Healthcare system.

### SUMMARY

Provided is a computerized method and system for health scoring and health risk assessment. In general, the system and method are designed to help users gain a better understanding of their overall health status and underlying health risk factors. It is believed that this may lead to users taking a more proactive approach towards improving their health.

In certain embodiments, a method for health scoring and health risk assessment involves collecting data on health-related activity and personal data of a user. The user may interact with a monitoring or tracking device(s) configured to tack or monitor his/her health-related activity. The collected health-related activity and personal data may be used to calculate a health score of the user based on various algorithms. This health score may be processed and published instantly, in real time, on a social network, web page or mobile application associated with the user.

Also provided is a system for health scoring and health risk assessment based on health-related activity and personal data of a user. The system may include a user personal data module and data collecting module to collect personal and health-related data of the user, a calculating module to calculate, based on the activity and personal data, a health score of the user, and an instant score processing module to process a health score to the user.

Additionally, the system may include a publishing module to publish user health score and health risk assessment results in a social network or any other web site and/or mobile application.

In further exemplary embodiments, modules, subsystems, or devices can be adapted to perform the recited steps. Other features and exemplary embodiments are described below.

### BRIEF DESCRIPTION OF THE DRAWING FIGURES

The accompanying drawings, which are incorporated into and form a part of the specification illustrates several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 is a block diagram illustrating an example of the overall system for health scoring and health risk assessment based on the personal data and health-related activity of a user, in accordance with various embodiments.

FIG. 2 is a block diagram showing various modules of the computer system for health scoring and health risk assessment based on personal data and health-related of a user, in accordance with certain embodiments.

FIG. 3 is a flow chart illustrating a method for health scoring and health risk assessment based on personal data and health-related activity of a user, in accordance with certain embodiments.

FIG. 4 is a user interface as can be used in an embodiment of the invention, showing the calculated health score, rank and level of progress.

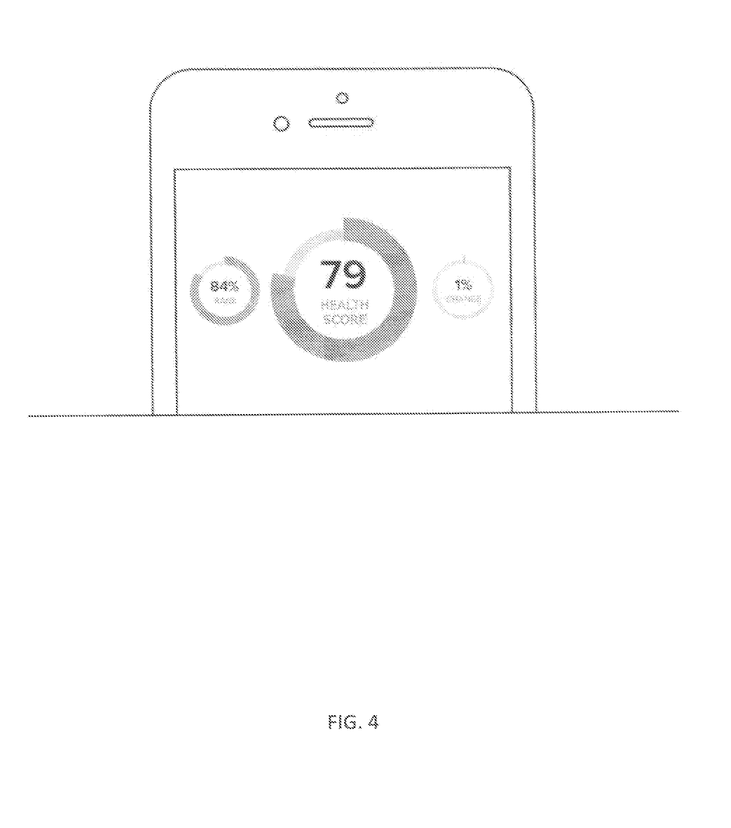

### DESCRIPTION OF CERTAIN EMBODIMENTS OF THE INVENTION

The following is a detailed description provided to aid those skilled in the art in practicing the present invention. Those of ordinary skill in the art may make modifications and variations in the embodiments described herein without departing from the spirit or scope of the present disclosure. Ali publications, patent applications, patents, figures and other references mentioned herein are expressly incorporated by reference in their entirety.

By way of overview and introduction, the invention described herein concerns a computerized method and system for health scoring and health risk assessment designed to help users to proactively manage their health. The invention is directed to assisting users gain a better understanding of the risk factors affecting their health. By proactively engaging with the information resulting from the health scoring and health risk assessment, users may be able to manage better their conditions and foresee recovery.

Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims. “or” should be understood to have the same meaning as ‘and/or’ as defined above. For example, when separating items in a list. “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of”.

In the claims, as well as in the specification above, all transitional phrases such as “comprising,” “including.” “carrying.” “having.” “containing,” “involving,” “holding.” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B” can refer. In one embodiment, to at least one, optionally including more than one, A, with no B present (and optionally including elements other than B); in another embodiment, to at least one, optionally including more than one, B with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

In certain embodiments, the user personal data is containing basic individual information including: first name; last name, email address; user name; the creation of a password; geography location (city and state); date of birth; weight measurements; height measurements; measurements system used; gender; level of physical activity; special diet followed (if any); weight goal; medical condition(s) (if any) with degree of severity; user picture; or the like. The information contained in a user personal data profile is also modifiable through the user interface. In one aspect, the user answers a survey aimed at assessing his/her general health status. Applicable survey questions include: level of intake of vegetables, fruit, dairy, meat, fish and sweets; level of physical activity; smoking; alcohol intake, stress level; or the like.

In certain embodiments, the user health-related activity is tracked or monitored by a microprocessor monitoring or tracking device. The microprocessor monitoring or tracking device is an innovative tool to capture health information about a user. In certain embodiments, the information is monitored or tracked by the microprocessor monitoring or tracking device, and recorded automatically by a device worn or carried, self-reported by a user by inputting data into, e.g., a mobile device.

In certain embodiments, the tracked or monitored data includes at least one of the following: users physical activity, sleep, diet, temperament, caloric intake, water intake, blood pressure, heart rate (pulse), mood, tobacco smoking, alcohol intake, tasting plasma glucose, cholesterol, HDL, body mass index (BMI), dietary supplement intake, medication dosage regimen, response to medication, genetic indicators, air quality or alike or combination thereof:

In certain embodiments, the health scorn that measures user's overall health standing is a number ranging between 0 and 100 that. In certain embodiments, a user health risk assessment is performed by evaluating a range of health risk factors. A separate score for each of the factors is calculated and measured as a percentage of designated target levels.

In certain embodiments, the system may also include art analysing module to analyse the health score of users to determine their underlying health risks, ranking and health score progress. The processor is configured to output the personal rank of each user by comparing their health score to the rest of the user population. The processor is also configured to calculate the level of progress for each user by comparing their current to historical health score data. Rewards may be given to users that demonstrate a preventative health care behavior.

Some embodiments, for example, may be used in conjunction with a Location-Based Service (LBS) application.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

The preceding general areas of utility are given by way of example only and are not intended to be limiting on the scope of the present disclosure and appended claims. Additional objects, features and advantages associated with the compositions, methods, and processes of the present invention will be appreciated by one of ordinary skill in the art in light of the instant claims, description, and examples, for example, the venous aspects and embodiments of the invention may be utilised in numerous combinations, ail of which are expressly contemplated by the present description. These additional advantages objects and embodiments are expressly included within the scope of the present invention. The publications and other materials used herein to illuminate the background of the invention, and in particular cases, to provide additional details respecting the practice, are incorporated by reference.

It is to be appreciated that the embodiments of this invention as discussed herein may be incorporated as a software algorithm, application, program or code residing in hardware, firmware and/or on a computer useable medium (including software modules and browser plug-ins) that can be executed in a processor of a computer system to configure the processor to perform the functions described below. Such a computer system typically includes memory storage configured to provide output from execution of the computer algorithm, code, or program. The processor may be configured to execute one or more modules.

The computer system preferably includes a processor (such as a digital data processor), a memory, and a control circuit. The memory stores data and instructions suitable for controlling the operation of processor. An implementation of memory can include, for example, a random access memory (RAM) a hard drive and a read only memory (ROM), or any of these components.

One or the components stored in memory is a program. Program includes instructions for controlling processor to perform particular tasks or implement particular abstract data types. Program may be implemented as a plurality of modules that operate in cooperation with one another. Program is contemplated as representing a software embodiment, or a component or module thereof, of the method described herein.

In embodiments of the present invention, portions of the program including selected modules or code thereof can execute entirely without user input or ether commands based on programmatic or automated access to a data signal flew through other systems that may or may not require a user interface for other reasons.

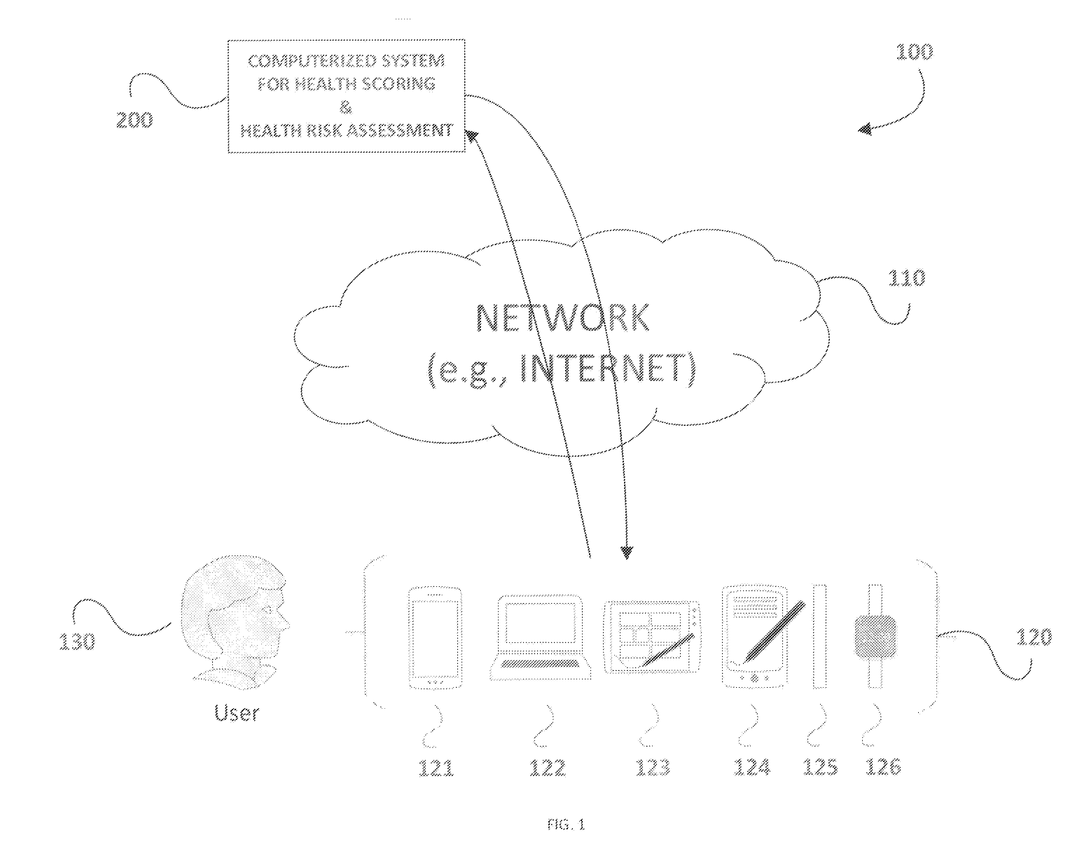

Referring now to figures, FIG. 1 is a block diagram illustrating an example of the overall computerized system for health scoring and health risk assessment 200 based on the activity data and the user personal data of a user, in accordance with various embodiments. FIG. 1 shows an architecture 100 that may include a network (the internet) 110, monitoring and tracking devices 120, a user 130 and a computerized system for health scoring and health risk assessment 200. The network 110 may include the internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAM), a frame relay connection, an Advanced Intelligent Network (AIN) connection, a synchronous optical network (SONET) connection, a digital T1, T3, E1 or E3 line, Digital Data Service (DOS) connection, DSL (Digital Subscriber Line) connection, an Ethernet connection, an iSDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion. Limited) duplex paging network. Bluetooth radio, or an IEEE 802.11-based radio frequency network. The network 110 can further include or interface with any one or more of an RS-232 serial connection, an, IEEE-1394 (Firewire) connection, a Fiber Channel connection, an IrDA (infrared) pod, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The monitoring and tracking devices 120, in some example embodiments, may include a Graphical User Interface (GUI). The monitoring and tracking devices 120 may be configured to utilize icons used in conjunction with text, labels, or text navigation to fully represent the information and actions available to users.

The monitoring and tracking devices 120 may include a “smartphone” device 121, a computer 122, a tablet 123, a personal digital assistant (PDA) 124, an activity tracker 125 and a “smartwatch” device. The user 130, in some example embodiments, is a person interacting with the monitoring and tracking devices 120 via an interface. The user 130 may periodically track or monitor his/her health related activity with the monitoring and tracking devices 128 and provide various information to the computerized system for health scoring and assessment 200. This information is stored and, in certain embodiments, analyzed by the computerized system for health scoring and health risk assessment 200 to create user specific information, such as user's profile. This information may include various health-related activity or user personal data of the user 130 including age, gender, weight measurements, height measurements, physical activity, sleep, diet, temperament, caloric intake, water intake, blood pressure, heart rate (pulses, mood, tobacco smoking, alcohol intake, fasting plasma glucose, cholesterol, HDL, body mass index (BMI), dietary supplement intake, medication dosage regimen, response to medication, genetic indicators or combination thereof physical activity, sleep, diet, temperament, caloric intake, head rate, pulse, mood, medication, dosage regimen, response to medication, genetic indicators, air quality or combination thereof and other types of information.

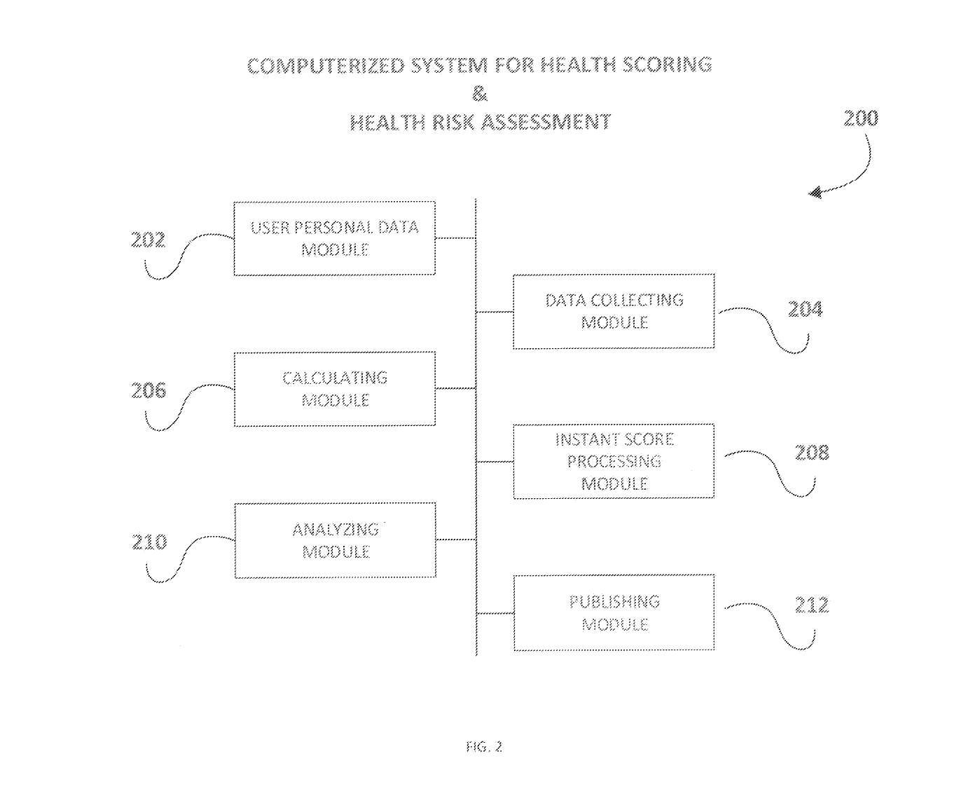

FIG. 2 illustrates a detailed block diagram of the computerized system for health scoring and health risk assessment 200 based on health-related activity and personal data of a user, in accordance with an example embodiment. The system for health scoring and assessment may include a user personal data module 202, a data collecting module 204, a calculating module 286, an instant score processing module 208, an analyzing module 210, and a publishing module 212.

The user personal data module 202 of the computerized system for health scoring and health risk assessment 200 may be configured to collect personal data (may include medical data) of a user. The personal data may include first name, last name, email address, user name, the creation of a password, geography location (city and state), date of birth, weight measurements, height measurements, measurement system, gender, level of physical activity, special diet followed (if any), weight goal, medical condition(s) (if any) with degree of severity or the like.

The data collecting module 204 of the system for health scoring and assessment 200 may be configured to collect data on the health-related activity of a user. The health-related activity data may include data related to user's physical activity, sleep, diet, temperament, caloric intake, water intake, blood pressure, heart rate (pulse), mood, tobacco smoking, alcohol intake, fasting plasma glucose, cholesterol, HDL, body mass index (BMI), dietary supplement intake, medication dosage regimen, response to medication, genetic indicators, air quality or combination thereof and other;

The calculating module 208 may be configured to calculate, based on the health-related activity and personal data of the user, a health score of the user. The collected health-related activity and personal data may be used to calculate a number, index, percentage, rating, or another indicant of a health score of the user based on various algorithms, in some embodiments, a health score of the user may be calculated for specific thematic or geographical areas, for specific activity types, for specific user groups, and so forth.

This calculated health score may be immediately processed for the user 130, via user interface on the monitoring and tracking devices 128 or otherwise, using the instant score processing module 208 of the system for hearth scoring and assessment 200.

The analyzing module 210 may be configured to analyze the health score of users to determine underlying high health risk factors and to determine the ranking and health score progress of users, and reward those users that meet specific conditions. Prizes may be provided by third parties. Analysis may so performed separately for specific thematic or geographical areas, activity types, user groups, and so forth.

Analysis results obtained by the analyzing module 210 may be also published, by the publishing module 212, in social networks or any other web site and/or mobile application. Additionally, the publishing module 212 may publish the health score and health risk assessment of the user in a web page or mobile application associated with the user.

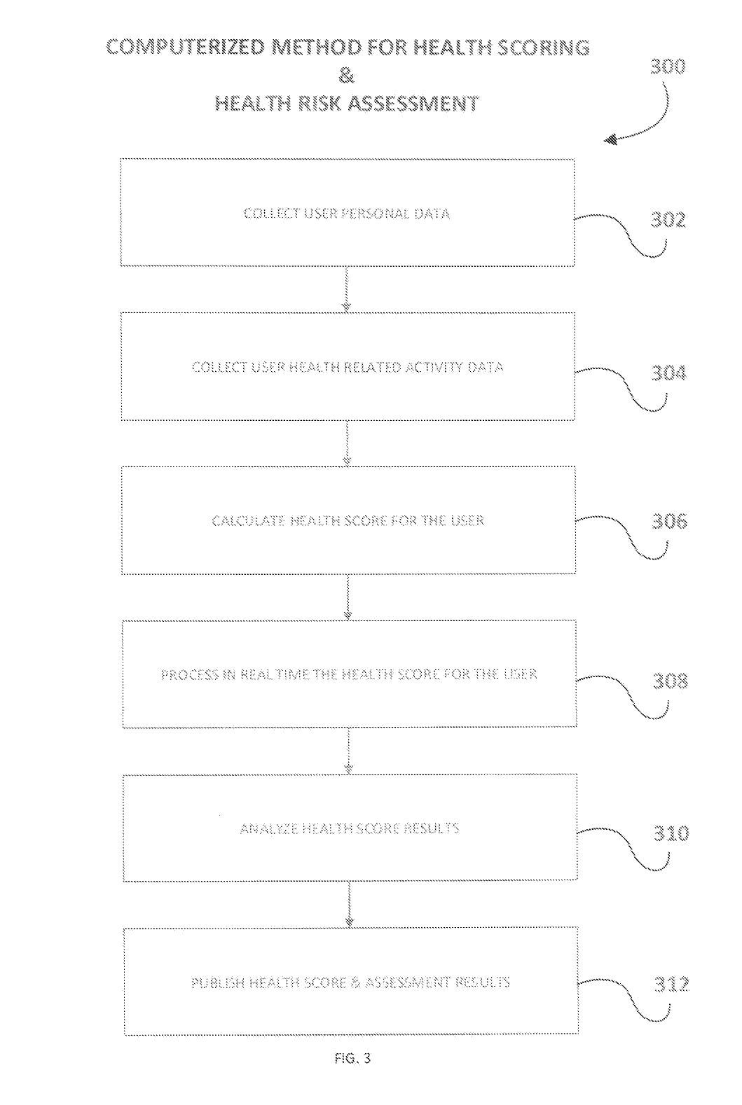

FIG. 3 shows a flow chart 300 of a method for health scoring and assessment based on health-related activity and personal data of a user, in accordance with an example embodiment. The method 300 may be performed by the various modules discussed above with reference to FIG. 2. Each of these modules may comprise processing logic.

As shown in FIG. 3, the method 300 may commence at operation 302, with the user personal data module 202 configured to collect personal data (may include medical data) of a user 130. At operation 304, the data collecting module 204 collects health-related activity data of a user 130 via tracking and monitoring devices 120. This data will be used by computerized system for health scoring and assessment 200 to calculate the health score of the user, at operation 300.

At operation 308, a health score of the user 130 may be instantly processed via the user interface of devices 120 or otherwise.

At operation 310, the analyzing module 210 may determine users with high health risk factors, rank users by their health score, show health score progress of users and reward those users that meet specific conditions.

At operation 313, the health scores and health risk assessment results of one or more users may be published via the user interface of the monitoring and tracking devices 120.

The present invention is described more fully with reference to the accompanying drawings. In which one or more illustrated embodiments of the invention are shown. The invention is not limited in any way to the illustrated embodiments as the illustrated embodiments described herein are merely exemplary of the invention, which can be embodied in various forms, as appreciated by one skilled in the art. Therefore, it is to be understood that any structural and functional details disclosed herein are not to be interpreted as limiting the invention, hut rather are provided as a representative embodiment for teaching one skilled so the art one or more ways to implement the invention. Furthermore, the terms and phrases used herein are not intended to be limiting, but rather are to provide an understandable description of the invention.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover ail such variations as tail within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims, it is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims

What is claimed is:

1. A computerized system for health scoring and health risk assessment based on health-related activity and personal data of the user, the system comprising:
a processor wherein configured to:
collect personal data of the user
collect data on the health-related activity of the user
calculate, based on the health-related activity and personal data of the user, a health score of the user;
instantly, in real time, process the health score of the user; and
publish the health score and health risk assessment results of the user

2. The system of claim 1, wherein the personal data of the user includes but is not limited to: first name; last name; email address; user name; the creation of a password; geography location (city and state); date of birth; weight measurements; height measurements; measurements system used; gender; level of physical activity; special diet followed (if any); weight goal; medical condition(s) (if any) with degree of severity; user picture; or the like.

3. The system of claim 1, wherein the health related activity of the user is monitored or tracked by a microprocessor device and includes at least one of: user's physical activity, sleep, diet, temperament, caloric intake, water intake, blood pressure, heart rate (pulse), mood, tobacco smoking, alcohol intake, fasting plasma glucose, cholesterol, HDL, body mass index (BMI), dietary supplement intake, medication dosage regimen, response to medication, genetic indicators, air quality or combination thereof and other;

4. The system of claim 1, wherein the processor is further configured to exchange information with the user.

5. The system of claim 1, wherein each specific type of the health-related activity monitored or tracked is assigned a specific numeric value, the specific numeric value to be immediately added to the health score of the user after the user performs the health-related activity of a specific type.

6. The system of claim 1, wherein the calculation of the health score is executed by a software algorithm utilizing a proprietary health scoring model.

7. The system of claim 1, wherein the processor is further configured to:
analyze the health score of a user to determine his/her underlying health risk;
determine the ranking and health score progress of a user and reward the user if he/she meets specific conditions.

8. The system of claim 1, wherein the processor is further configured to publish the health scores and health risk assessment results of one or more users.

9. A computerized method for health scoring and health risk assessment based on health-related activity and personal data of the user, the method comprising:
collecting, by the processor, personal data of the user;
collecting, by the processor, health-related activity data of the user;
calculating, by the processor, based on the activity and the personal data of the user, a health score;
performing, by the processor, based on the activity data and the personal data of the user, a health risk assessment;
publishing, immediately in real-time, the health score and health risk assessment results of the user.

10. The method of claim 9, wherein the personal data of the user includes but is not limited to: first, name; last name; email address; user name; the creation of a password; geography location (city and state); date of birth; weight measurements; height measurements; measurements system used; gender; level of physical activity; special diet followed (if any); weight goal; medical condition(s) (if any) with degree of severity; user picture; or the like.

11. The method of claim 9, wherein the health-related activity of the user is monitored or tracked by a microprocessor device and includes at least one of: user's physical activity, sleep, diet, temperament, caloric intake, water intake, blood pressure, heart rate (pulse), mood, tobacco smoking, alcohol intake, lasting plasma glucose, cholesterol, HDL, body mass index (BMI), dietary supplement intake, medication dosage regimen, response to medication, genetic indicators, air quality or combination thereof and other;

12. The method of claim 9, further comprising exchanging information with the user.

13. The method of claim 9, wherein each specific type of the health-related activity tracked or monitored is assigned a specific numeric value, the specific numeric value to be immediately added to the health score of the user after the user performs the online activity of a specific type.

14. The method of claim 9, wherein the calculation of the health score is executed by a software algorithm utilizing a proprietary health scoring model.

15. The method of claim 9, further comprising:
analyzing the health score of a user to determine his/her underlying health risks:
determining the ranking and health score progress of a user and reward the user if he/she meets specific conditions.

16. The method of claim 9, further comprising publishing the health scores and health risk assessment results of one or more users.
